(19) United States
(12) Patent Application Publication
(10) Pub. No.: US 2025/0156902 A1
(43) Pub. Date: May 15, 2025

(54) INFORMATION PROCESSING DEVICE, INFORMATION PROCESSING SYSTEM, AND INFORMATION PROCESSING METHOD

(71) Applicant: Sharp NEC Display Solutions, Ltd., Tokyo (JP)

(72) Inventor: Yoshinori MORIKI, Tokyo (JP)

(21) Appl. No.: 19/024,429

(22) Filed: Jan. 16, 2025

Related U.S. Application Data
(63) Continuation of application No. PCT/JP2022/033102, filed on Sep. 2, 2022.

(51) Int. Cl. G06Q 30/0251

(52) U.S. Cl. CPC G06Q 30/0255; G06Q 30/0269

(57) ABSTRACT

There is provided an information processing device including a display control unit configured to cause a display device installed at a position in a store to display an advertisement on the basis of customer data including information in which viewed advertisement information indicating an advertisement viewed by a first customer out of advertisements displayed on the display device, purchased product information indicating a product purchased by the first customer, and customer attribute information indicating attributes of the first customer are correlated and a first captured image in which a first imaging area including a position at which an advertisement displayed on the display device is visible is imaged.

### TECHNICAL FIELD

The present invention relates to an information processing device, an information processing system, and an information processing method.

### BACKGROUND ART

Techniques of displaying an advertisement based on attributes of a person viewing a display device on the display device have been studied and developed.

In this regard, an advertisement display system including a first imaging device that images a customer and that is provided outside of a store and a display control device that displays an advertisement on a display device installed outside of the store is known. Here, the display control device includes a storage unit configured to store identification information of a customer purchasing a product in the store and attribute information of the customer in correlation, an identification unit configured to analyze an image captured by the first imaging device and to identify identification information corresponding to a customer included in the image, and a display control unit configured to display an advertisement on the display device on the basis of the attribute information stored in the storage unit in correlation with the identified identification information (see Patent Document 1).

### CITATION LIST

### Patent Document

### [Patent Document 1]

Japanese Unexamined Patent Application, First Publication No. 2017-204013

### SUMMARY OF INVENTION

### Technical Problem

Here, the advertisement display system described in Patent Document 1 cannot identify a correlation among attributes of a customer, products purchased by the customer, and advertisements viewed by the customer. As a result, the advertisement display system may display an advertisement with a low effect of sales promotion on the display device.

The present invention was made in consideration of the aforementioned circumstances, and an objective thereof is to provide an information processing device, an information processing system, and an information processing method that can curb displaying of an advertisement with a low effect of sales promotion on a display device.

### Solution to Problem

According to an aspect of the present invention, there is provided an information processing device including a display control unit configured to cause a display device installed at a position in a store to display an advertisement on the basis of customer data including information in which viewed advertisement information indicating an advertisement viewed by a first customer out of advertisements displayed on the display device, purchased product information indicating a product purchased by the first customer, and customer attribute information indicating attributes of the first customer are correlated and a first captured image in which a first imaging area including a position at which an advertisement displayed on the display device is visible is imaged.

According to an aspect of the present invention, there is provided an information processing system including a display device installed at a position in a store and an information processing device configured to cause the display device to display an advertisement, wherein the information processing device includes a display control unit configured to cause the display device to display an advertisement on the basis of customer data including information in which viewed advertisement information indicating an advertisement viewed by a first customer out of advertisements displayed on the display device, purchased product information indicating a product purchased by the first customer, and customer attribute information indicating attributes of the first customer are correlated and a first captured image in which a first imaging area including a position at which an advertisement displayed on the display device is visible is imaged.

According to an aspect of the present invention, there is provided an information processing method including causing a display device installed at a position in a store to display an advertisement on the basis of customer data including information in which viewed advertisement information indicating an advertisement viewed by a first customer out of advertisements displayed on the display device, purchased product information indicating a product purchased by the first customer, and customer attribute information indicating attributes of the first customer are correlated and a first captured image in which a first imaging area including a position at which an advertisement displayed on the display device is visible is imaged.

### Advantageous Effects of Invention

According to the present invention, it is possible to curb displaying of an advertisement with a low effect of sales promotion on a display device.

### BRIEF DESCRIPTION OF DRAWINGS

FIG. 1 is a diagram illustrating an example of a configuration of an information processing system 1.

FIG. 2 is a diagram illustrating an example of a hardware configuration of an information processing device 30.

FIG. 3 is a diagram illustrating an example of a functional configuration of the information processing device 30.

FIG. 4 is a diagram illustrating an example of a process flow in which the information processing device 30 displays an advertisement on a display device 21.

FIG. 5 is a diagram illustrating an example of an interrupt process flow that is performed by the information processing device 30.

FIG. 6 is a diagram illustrating an example in which an advertisement for previously notifying that a type of bread indicated by baked bread information is baked at the time indicated by scheduled baking time information is displayed on the display device 21.

FIG. 7 is a diagram illustrating another example in which an advertisement for previously notifying that a type of bread indicated by baked bread information is baked at the time indicated by scheduled baking time information is displayed on the display device 21.

FIG. 8 is a diagram illustrating an example in which an advertisement for previously notifying of a limited-time sale is displayed on the display device 21.

FIG. 9 is a diagram illustrating an example in which a moving image in which freshly baked bread is reflected is displayed as an interrupt advertisement on the display device 21.

FIG. 10 is a diagram illustrating an example of a process flow in which the information processing device 30 ends display of an interrupt advertisement.

FIG. 11 is a diagram illustrating an example of a process flow in which the information processing device 30 generates customer data.

FIG. 12 is a diagram illustrating another example of the functional configuration of the information processing device 30.

### DESCRIPTION OF EMBODIMENTS

### Embodiment

Hereinafter, an embodiment of the present invention will be described with reference to the accompanying drawings.

### <Outline of Information Processing System>

An outline of an information processing system according to an embodiment will be first described below.

The information processing system according to this embodiment includes a display device and an information processing device. The display device is installed at a position in a store. The information processing device includes a display control unit. The display control unit displays an advertisement on the display device on the basis of customer data and a first captured image. The customer data is data including information in which viewed advertisement information, purchased product information, and customer attribute information are correlated. The viewed advertisement information is information indicating an advertisement viewed by a first customer out of advertisements displayed on the display device. The purchased product information is information indicating a product purchased by the first customer. The customer attribute information is information indicating attributes of the first customer. The first captured image is a captured image in which a first imaging area is imaged. The first imaging area is an area including a position at which an advertisement displayed on the display device is visible.

Accordingly, the information processing system according to the embodiment can curb displaying of an advertisement with a low effect of sales promotion on the display device.

A configuration of the information processing system according to the embodiment, a configuration of the information processing device provided in the information processing system, and processes that are performed by the information processing device will be described below in detail.

### <Configuration of Information Processing System>

The configuration of the information processing system according to the embodiment and the configuration of the information processing device provided in the information processing system will be described below with an information processing system 1 as an example of the information processing system according to the embodiment.

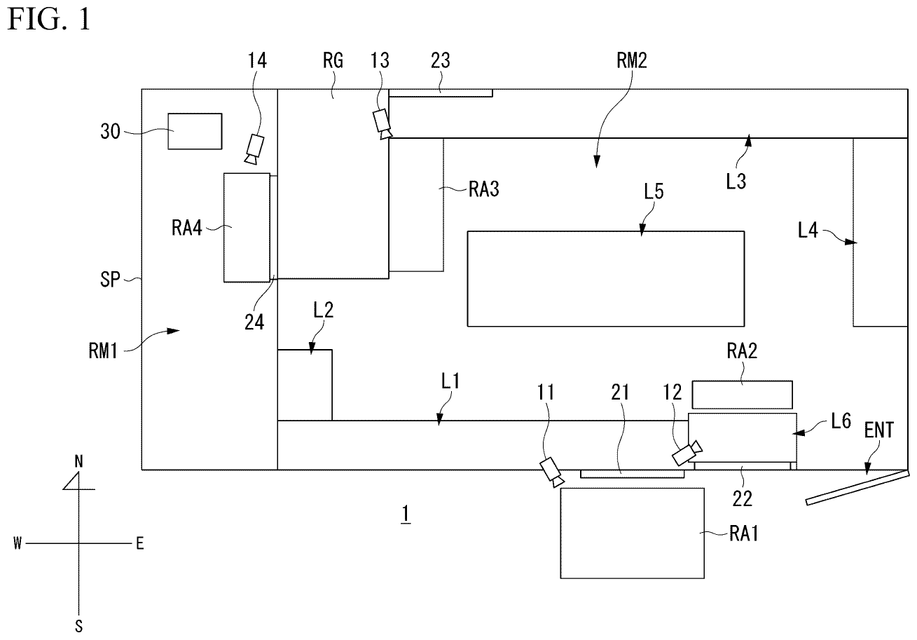

FIG. 1 is a diagram illustrating an example of the configuration of the information processing system 1.

The information processing system 1 causes a display device provided in a predetermined store to display an advertisement. In the following description, it is assumed that the store is a store SP illustrated in FIG. 1. The store SP is, for example, a store that produces and sells bread. In this case, bread is an example of a product. The store SP may be a store that sells bread, a store that produces and sells foods other than bread, a store that sells foods other than bread, a store that produces and sells products other than foods, a store that sells products other than foods, a store that provides a service, or another type of store. Examples of the products other than bread include snacks, set meals, fruits, and coffee, but the present invention is not limited thereto. Examples of the products other than foods include clothing, tools, sundries, and flowers, but the present invention is not limited thereto. Examples of the service include cleaning and repairing, but the present invention is not limited thereto.

In the example illustrated in FIG. 1, the inside of the store SP is partitioned into two areas. One of the two areas is a kitchen RM1 in which bread is produced by kitchen staffs. The other of the two areas is a hall RM2 in which bread is sold by hall staffs. Some or all of the kitchen staffs may also serve as hall staff.

In the example illustrated in FIG. 1, an entrance ENT of the store SP is provided on a south wall of the hall RM2. In the example, five racks such as racks L1 to L5 on which bread is displayed and a rack L6 on which tongs for grasping bread, trays on which bread to be purchased is placed, and the like are placed are disposed in the hall RM2. The rack L1 is disposed along a south inner wall out of inner walls of the hall RM2. The rack L2 is disposed along a west inner wall out of the inner walls of the hall RM2. The rack L3 is disposed along a north inner wall out of the inner walls of the hall RM2. The rack L4 is disposed along an east inner wall out of the inner walls of the hall RM2. The rack L5 is disposed in the vicinity of the center of the hall RM2. In the hall RM2, the rack L6 is disposed between the entrance ENT and the rack L1. In the hall RM2 of the store SP, a customer of the store SP purchases a type of bread which the customer wants to purchase out of various types of bread displayed on the racks L1 to L5.

In the example illustrated in FIG. 1, a register counter RG at which a customer of the store SP performs a procedure for purchasing bread is disposed in the vicinity of the rack L2 in the hall RM2. A cash register, a point of sales (POS) system, or the like is placed on the register counter RG. Accordingly, a customer of the store SP can purchase a type of bread which the customer wants to purchase at the register counter RG. In FIG. 1, a cash register, a POS system, or the like is not illustrated for the purpose of simplification of the drawing.

The information processing system 1 causes a display device installed in the store SP to display an advertisement to customers of the store SP, persons who may be customers of the store SP, and the like. Accordingly, the information processing system 1 promotes bread purchase desires of the customers of the store SP, the persons who may be customers of the store SP, and the like.

The information processing system 1 includes, for example, an imaging unit 11, a display device 21, an imaging unit 12, a display device 22, an imaging unit 13, a display device 23, an imaging unit 14, a display device 24, and an information processing device 30. The information processing system 1 may not include some or all of the imaging units 11 to 14. The information processing system 1 may not include some or all of the display devices 22 to 24.

The imaging unit 11 is, for example, a camera including a charge-coupled device (CCD) or a complementary metal oxide semiconductor (CMOS) as an imaging element for converting collected light into an electrical signal. The imaging unit 11 is provided at a predetermined first position. The first position is a position at which a first imaging area RA1 can be imaged. The first imaging area RA1 is not particularly limited as long as it is an area including a position at which an advertisement displayed on the display device 21 is visible. In the example illustrated in FIG. 1, the display device 21 is provided on an outer wall on which the entrance ENT is provided out of the outer walls of the store SP. Accordingly, in the example, the first imaging area RA1 is an area including a position at which an advertisement displayed on the display device 21 on the outer wall is visible and is an area located in front of the outer wall. That is, the first imaging area RA1 is an area in which a person viewing an advertisement displayed on the display device 21 out of persons passing in the vicinity of the entrance ENT of the store SP is assumed to stop. The display device 21 is a display device that displays an advertisement to persons passing in the vicinity of the entrance ENT of the store SP. The imaging unit 11 may capture a still image in a range in which the imaging unit 11 can capture an image or may capture a moving image in that range. In the following description, for example, it is assumed that the imaging unit 11 captures a moving image in that range. The imaging unit 11 sequentially outputs frames of a moving image obtained by imaging that range as a first captured image to the information processing device 30. The imaging unit 11 is communicatively connected to the information processing device 30 in a wireless or wired manner. In FIG. 1, a wireless or wired communication path for connecting the imaging unit 11 and the information processing device 30 is not illustrated for the purpose of simplification of the drawing.

The display device 21 is, for example, a display device including a display panel such as a liquid crystal display panel or an organic electroluminescence (EL) display panel. The display device 21 is installed at a position in the store SP. In the example illustrated in FIG. 1, the display device 21 is provided on the outer wall on which the entrance ENT is provided out of the outer walls of the store SP as described above. The display device 21 is communicatively connected to the information processing device 30 in a wireless or wired manner. In FIG. 1, a wireless or wired communication path for connecting the display device 21 and the information processing device 30 is not illustrated for the purpose of simplification of the drawing.

The imaging unit 12 is, for example, a camera including a CCD or a CMOS as an imaging element for converting collected light into an electrical signal. The imaging unit 12 is provided at a predetermined second position. The second position is a position at which a second imaging area RA2 can be imaged. The second imaging area RA2 is not particularly limited as long as it is an area including a position at which an advertisement displayed on the display device 22 is visible. In the example illustrated in FIG. 1, the display device 22 is provided at a position in the vicinity of the top of the rack L6 in the store SP. Accordingly, in the example, the second imaging area RA2 is an area including a position at which an advertisement displayed on the display device 22 is visible and is an area located in front of the rack L6. That is, the second imaging area RA2 is an area in which a person viewing an advertisement displayed on the display device 22 out of persons taking tongs, trays, or the like from the rack L6 in the store SP is assumed to stop. The display device 22 is a display device that displays an advertisement to persons taking tongs, trays, or the like from the rack L6 in the store SP. The imaging unit 12 may capture a still image in a range in which the imaging unit 12 can capture an image or may capture a moving image in that range. In the following description, for example, it is assumed that the imaging unit 12 captures a moving image in that range. The imaging unit 12 sequentially outputs frames of a moving image obtained by imaging that range as a second captured image to the information processing device 30. The imaging unit 12 is communicatively connected to the information processing device 30 in a wireless or wired manner. In FIG. 1, a wireless or wired communication path for connecting the imaging unit 12 and the information processing device 30 is not illustrated for the purpose of simplification of the drawing.

The display device 22 is, for example, a display device including a display panel such as a liquid crystal display panel or an organic electroluminescence (EL) display panel. The display device 22 is installed at a position in the store SP. In the example illustrated in FIG. 1, the display device 22 is provided at a position in the vicinity of the top of the rack L6 in the store SP as described above. The display device 22 is communicatively connected to the information processing device 30 in a wireless or wired manner. In FIG. 1, a wireless or wired communication path for connecting the display device 22 and the information processing device 30 is not illustrated for the purpose of simplification of the drawing.

The imaging unit 13 is, for example, a camera including a CCD or a CMOS as an imaging element for converting collected light into an electrical signal. The imaging unit 13 is provided at a predetermined third position. The third position is a position at which a third imaging area RA3 can be imaged. The third imaging area RA3 is not particularly limited as long as it is an area including a position at which persons purchasing bread stop at the register counter RG. That is, the third imaging area RA3 is an area in which persons purchasing bread are assumed to stop at the register counter RG. The display device 23 is a display device that displays an advertisement to persons performing a bread purchasing procedure in the store SP. The imaging unit 13 may capture a still image in a range in which the imaging unit 13 can capture an image or may capture a moving image in that range. In the following description, for example, it is assumed that the imaging unit 13 captures a moving image in that range. The imaging unit 13 sequentially outputs frames of a moving image obtained by imaging that range as a third captured image to the information processing device 30. The imaging unit 13 is communicatively connected to the information processing device 30 in a wireless or wired manner. In FIG. 1, a wireless or wired communication path for connecting the imaging unit 13 and the information processing device 30 is not illustrated for the purpose of simplification of the drawing.

The display device 23 is, for example, a display device including a display panel such as a liquid crystal display panel or an organic electroluminescence (EL) display panel. The display device 23 is installed at a position in the store SP. In the example illustrated in FIG. 1, the display device 23 is provided at a position in the vicinity of the register counter RG and the top of the rack L3 in the store SP. The display device 23 is communicatively connected to the information processing device 30 in a wireless or wired manner. In FIG. 1, a wireless or wired communication path for connecting the display device 23 and the information processing device 30 is not illustrated for the purpose of simplification of the drawing.

The imaging unit 14 is, for example, a camera including a CCD or a CMOS as an imaging element for converting collected light into an electrical signal. The imaging unit 14 is provided at a predetermined fourth position. The fourth position is a position at which a fourth imaging area RA4 can be imaged. The fourth imaging area RA4 is not particularly limited as long as it is an area in the kitchen RM1. For example, the fourth imaging area RA4 is an area including a position at which a subject which a kitchen staff wants to image is located. In the example illustrated in FIG. 1, the fourth imaging area RA4 is an area including a table on which freshly baked bread is temporarily placed in the kitchen RM1. The imaging unit 14 may capture a still image in a range in which the imaging unit 14 can capture an image or may capture a moving image in that range. In the following description, for example, it is assumed that the imaging unit 14 captures a moving image in that range. The imaging unit 14 sequentially outputs frames of a moving image obtained by imaging that range as a fourth captured image to the information processing device 30. The imaging unit 14 is communicatively connected to the information processing device 30 in a wireless or wired manner. In FIG. 1, a wireless or wired communication path for connecting the imaging unit 14 and the information processing device 30 is not illustrated for the purpose of simplification of the drawing.

The display device 24 is, for example, a display device including a display panel such as a liquid crystal display panel or an organic electroluminescence (EL) display panel. The display device 24 is installed at a position in the store SP. In the example illustrated in FIG. 1, the display device 24 is provided at a position in the vicinity of the top of the fourth imaging area RA4 in the kitchen RM1. The display device 24 is communicatively connected to the information processing device 30 in a wireless or wired manner. In FIG. 1, a wireless or wired communication path for connecting the display device 24 and the information processing device 30 is not illustrated for the purpose of simplification of the drawing.

The information processing device 30 is, for example, a desktop personal computer (PC), a workstation, a laptop PC, a tablet PC, a multi-function mobile phone terminal (a smartphone), a mobile phone terminal, or a person digital assistant (PDA), but is not limited thereto.

Customer data is stored in the information processing device 30. The customer data is data including information in which viewed advertisement information, purchased product information, and customer attribute information are correlated. In the following description, for example, it is assumed that the customer data is data in a table format in which records in which customer identification information, viewed advertisement information, purchased product information, and customer attribute data are correlated are stored. The customer data may be another type of data (with another data structure) instead of such data in a table format.

Here, the customer identification information is not particularly limited as long as it is information for identifying customers and is, for example, an identifier (ID) for identifying a customer.

Viewed advertisement information correlated with certain customer identification information is information indicating an advertisement viewed by a customer identified by the customer identification information out of advertisements displayed on the display device 21. The viewed advertisement information may be information indicating an advertisement viewed by a customer identified by the customer identification information out of advertisements displayed on the display device 22. The viewed advertisement information may be information indicating an advertisement viewed by a customer identified by the customer identification information out of advertisements displayed on the display device 23. The viewed advertisement information may be information indicating an advertisement viewed by a customer identified by the customer identification information out of advertisements displayed on the display devices 21 and 22. The viewed advertisement information may be information indicating an advertisement viewed by a customer identified by the customer identification information out of advertisements displayed on the display devices 21 and 23. The viewed advertisement information may be information indicating an advertisement viewed by a customer identified by the customer identification information out of advertisements displayed on the display devices 22 and 23. The viewed advertisement information may be information indicating an advertisement viewed by a customer identified by the customer identification information out of advertisements displayed on the display devices 21 to 23.

Purchased product information correlated with certain customer identification information is information indicating a product purchased by a customer identified by the customer identification information. That is, in this embodiment, the purchased product information is information indicating a type of bread purchased by the customer identified by the customer identification information.

The customer attribute information correlated with certain customer identification information is information indicating attributes of a customer identified by the customer identification information. Attributes of the customer includes some or all of sex, age, and clothing features of the customer and information indicating whether a child is accompanied. In the following description, for example, it is assumed that the customer attribute information includes sex information indicating sex of the customer, age information indicating age of the customer, clothing information indicating clothing features of the customer, and a child-accompanied flag indicating whether the customer accompanies a child. The customer attribute information may include other information indicating attributes of the customer.

The information processing device 30 determines an advertisement to be displayed on the display device 21 as a target advertisement on the basis of the customer attribute data and the first captured image acquired from the imaging unit 11. The information processing device 30 causes the display device 21 to display the determined target advertisement. In the embodiment, an advertisement is an image for sales promotion and may be a still image or a moving image. In the embodiment, an advertisement may be an image with sound or an image without sound. When an advertisement is an image with sound, the display device 21 includes a speaker.

Here, whenever the first captured image is acquired from the imaging unit 11, the information processing device 30 determines whether one or more persons are included in the first captured image acquired from the imaging unit 11. A method of determining whether one or more persons are included in the first captured image may be a known method or may be a method which will be developed in the future.

When no persons are included in the first captured image acquired from the imaging unit 11, the information processing device 30 determines a predetermined first image as a target advertisement to be displayed on the display device 21. The first image is not particularly limited as long as it is an image predetermined by a storekeeper of the store SP, a kitchen staff, or the like and is, for example, an image which is estimated to obtain an effect of bread sales promotion from a person with any attributes.

On the other hand, for example, when one or more persons are included in the first captured image acquired from the first imaging unit 11, the information processing device 30 identifies attributes of the person on the basis of the first captured image. At this time, the information processing device 30 sets a child-accompanied flag to 0 because the person does not accompany a child. A method of identifying attributes other than the child-accompanied flag out of attributes of the person on the basis of the first captured image may be a known method or may be a method which will be developed in the future. After attributes of the person have been identified, the information processing device 30 identifies a record including customer attribute information matching the customer attribute information indicating attributes of the identified person as a first target record with reference to customer data stored in advance therein. For example, when the number of identified first target records is one, the information processing device 30 identifies an advertisement indicated by the viewed advertisement information included in the identified first target record as a target advertisement. Then, the information processing device 30 causes the display device 21 to display the identified target advertisement. For example, when the number of identified first target records is two or more, the information processing device 30 identifies a type of bread indicated by the purchased product information included in each of the two or more identified first target records. The information processing device 30 identifies a type of bread with a highest identification frequency out of the identified types of bread, wherein the identification frequency refers to how frequently a respective type of bread is identified, relative to other types of breads. For example, when the number of identified first target records is 3 and the types of bread indicated by the purchased product information included in the three identified first target records are croissant, croissant, and curry bread, the information processing device 30 identifies the type of bread with a highest identification frequency out of the identified types of bread as croissant and identifies croissant as target bread. After the target bread has been identified, the information processing device 30 identifies the first target record including the purchased product information indicating the identified target bread out of the two or more identified first target records as a second target record. When the number of identified second target records is one, the information processing device 30 identifies an advertisement indicated by the viewed advertisement information included in the identified second target record as the target advertisement. When the number of identified second target records is two or more, the information processing device 30 identifies an advertisement indicated by the viewed advertisement information included in each of the two or more identified second target records. The information processing device 30 identifies an advertisement with a highest identification frequency out of the identified advertisements as a target advertisement. The information processing device 30 causes the display device 21 to display the identified target advertisement. The information processing device 30 may identify a plurality of advertisements from the highest ranking to a predetermined ranking out of the list in which the identified advertisements are arranged in the descending order of identification frequencies as target advertisements. At this time, the information processing device 30 handles overlapping advertisements as one advertisement. In this case, the information processing device 30 causes the display device 21 to display the two or more identified advertisements, for example, by screen division, a slide show, or the like. Here, the predetermined ranking is, for example, a third ranking, but the present invention is not limited thereto.

For example, when a plurality of persons are included in the first captured image acquired from the imaging unit 11, the information processing device 30 identifies a target advertisement using the aforementioned method for each of the plurality of persons. At this time, the information processing device 30 identifies overlapping target advertisements as a target advertisement. At this time, when the plurality of persons include a child, the information processing device 30 sets the child-accompanied flag of a person which is an adult out of the plurality of persons to 1. The information processing device 30 causes the display device 21 to display all of the identified one or more target advertisements by screen division. Without causing the display device 21 to display all of the identified one or more target advertisements by screen division, the information processing device 30 may cause the display device 21 to sequentially display the one or more target advertisements cyclically like a slide show. The information processing device 30 may apply identification of the target advertisements from the highest ranking as identification of the one or more target advertisements.

By identifying the target advertisements as described above, the information processing device 30 can curb displaying of an advertisement with a low effect of sales promotion on the display device 21 to the persons included in the first captured image. This is because the number of parameters for identifying the target advertisements increases in comparison with a case in which the target advertisements are simply determined on the basis of correlations between attributes and purchased products, and thus a probability for identifying an advertisement with a high effect of sales promotion as a target advertisement is enhanced.

Here, the information processing device 30 may determine an advertisement to be displayed on the display device 22 on the basis of the second captured image acquired from the imaging unit 12 using the same method as the method of identifying the target advertisements. In this case, the information processing device 30 can cause the display device 22 to display an advertisement with a higher effect of sales promotion to a customer having already entered the store SP.

The information processing device 30 may cause at least one of the display device 22 and the display device 23 to display the same advertisement as the advertisement to be displayed on the display device 21. In this case, the advertisement displayed on the display device changes randomly whenever a person passes through the first imaging area RA1. As a result, the information processing device 30 can notify a customer staying in the store SP that the customer has a taste other than the customer's known taste. This is important because new demand is created in addition to the known demand of customers of the store SP.

The information processing device 30 may cause at least one of the display device 22 and the display device 23 to display the first image.

The information processing device 30 may cause the display device 24 to display the first captured image, or to display the same image as an image displayed on one of the display device 21, the display device 22, and the display device 23, to display a fourth captured image, or to display another type of image. An example of the other type of image is an operation image for receiving an operation on the information processing device 30 (for example, a graphical user interface (GUI) of an operating system (OS) installed in the information processing device 30).

### <Hardware Configuration of Information Processing Device>

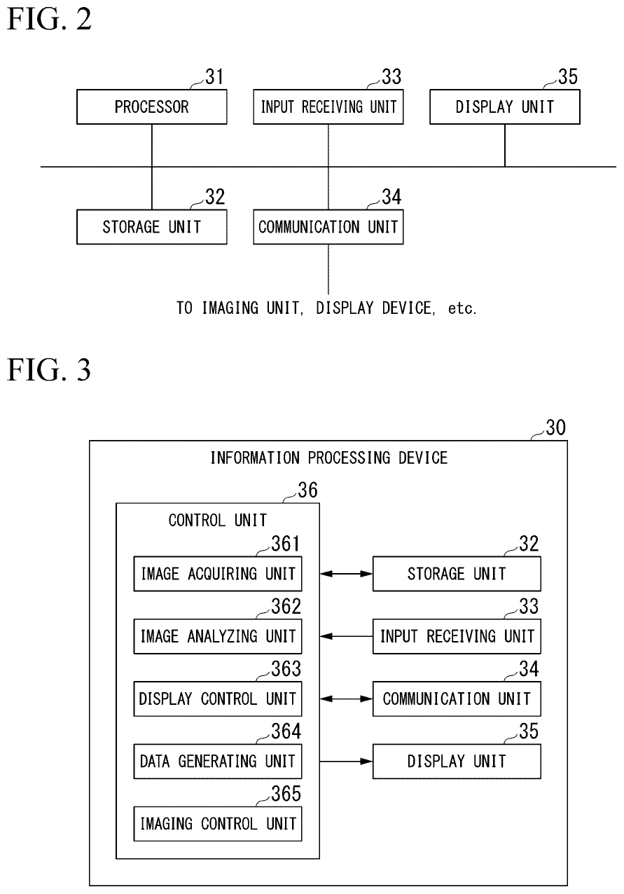

A hardware configuration of the information processing device 30 will be described below with reference to FIG. 2. FIG. 2 is a diagram illustrating an example of the hardware configuration of the information processing device 30.

The information processing device 30 includes, for example, a processor 31, a storage unit 32, an input receiving unit 33, a communication unit 34, and a display unit 35. The information processing device 30 communicates with the imaging unit 11, the imaging unit 12, the imaging unit 13, the imaging unit 14, the display device 21, the display device 22, the display device 23, the display device 24, and the like via the communication unit 34. These constituents are communicatively connected to each other via a bus.

The processor 31 is, for example, a central processing unit (CPU). The processor 31 may be another processor such as a field-programmable gate array (FPGA) instead of the CPU. The processor 31 executes various programs stored in the storage unit 32. The processor 31 may be constituted by a CPU of one information processing device (the information processing device 30 in this example) or may be constituted by CPUs of a plurality of information processing devices.

The storage unit 32 includes, for example, a hard disk drive (HDD), a solid state drive (SSD), an electrically erasable programmable read only memory (EEPROM), a read only memory (ROM), and a random access memory (RAM). The storage unit 32 may not be incorporated into the information processing device 30 but may be an externally attachable storage device connected using a digital input/output port such as a universal serial bus (USB). The storage unit 32 stores various types of information to be processed by the information processing device 30, various programs, and the like.

The input receiving unit 33 is an input device such as a keyboard, a mouse, or a touch pad. The input receiving unit 33 may be a touch panel which is formed as a unified body with the display unit 35.

The communication unit 34 includes, for example, a digital input/output port such as a USB, an Ethernet (registered trademark) port, and a communication antenna.

The display unit 35 is, for example, a display panel such as a liquid crystal display panel or an organic electroluminescence (EL) display panel.

### <Functional Configuration of Information Processing Device>

A functional configuration of the information processing device 30 will be described below with reference to FIG. 3. FIG. 3 is a diagram illustrating an example of the functional configuration of the information processing device 30.

The information processing device 30 includes a storage unit 32, an input receiving unit 33, a communication unit 34, a display unit 35, and a control unit 36.

The control unit 36 controls the information processing device 30 as a whole. The control unit 36 includes an image acquiring unit 361, an image analyzing unit 362, a display control unit 363, a data generating unit 364, and an imaging control unit 365. These functional units of the control unit 36 are realized, for example, by causing the processor 31 to execute various programs stored in the storage unit 32. Some or all of the functional units may be hardware functional units such as a large scale integration (LSI) device or an application-specific integrated circuit (ASIC).

The image acquiring unit 361 sequentially acquires frames of a moving image captured by the imaging unit 11 as the first captured image. The image acquiring unit 361 sequentially acquires frames of a moving image captured by the imaging unit 12 as the second captured image. The image acquiring unit 361 sequentially acquires frames of a moving image captured by the imaging unit 13 as the third captured image. The image acquiring unit 361 sequentially acquires frames of a moving image captured by the imaging unit 14 as the fourth captured image.

The image analyzing unit 362 performs extraction, detection, identification, and the like of various types of information through image analysis based on the images acquired by the information processing device 30.

The display control unit 363 generates various types of images to be displayed on the display unit 35. The display control unit 363 cause the display unit 35 to display the generated images. The display control unit 363 causes the display devices 21 to 24 to display advertisements.

The data generating unit 364 generates the customer data.

The imaging control unit 365 controls the imaging units 11 to 14.

<Process Flow in which Information Processing Device Causes Display Device to Display Advertisement>

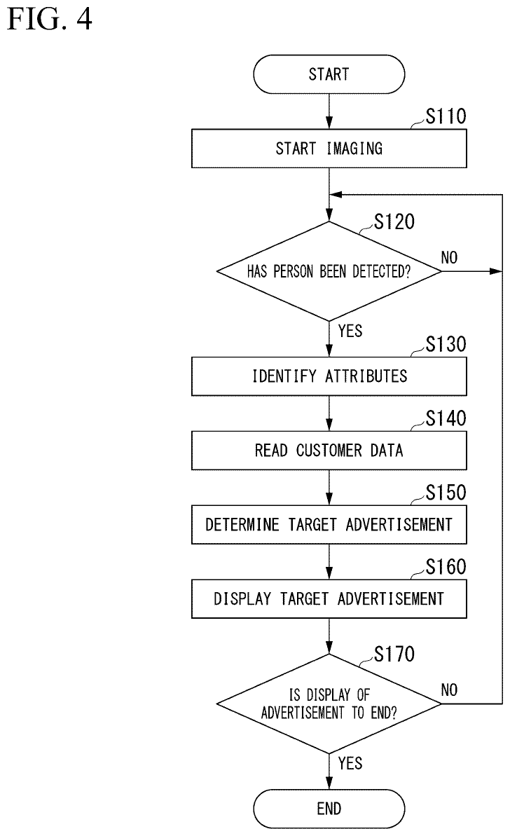

A process flow in which the information processing device 30 causes the display device 21 to display advertisements will be described below with reference to FIG. 4. FIG. 4 is a diagram illustrating an example of a process flow in which the information processing device 30 causes the display device 21 to display advertisements. In the following description, for example, it is assumed that a process start operation for causing the information processing device 30 to start a process flow in which the information processing device 30 causes the display device 21 to display an advertisement is received by the information processing device 30 at a timing before the process of Step S110 illustrated in FIG. 4 is performed. In the following description, for example, it is assumed that customer data is stored in the storage unit 32 at the timing. In the following description, for example, it is assumed that a plurality of advertisements that can displayed as target advertisements on the display device 21 are stored in the storage unit 32.

After the process start operation has been received by the information processing device 30, the imaging control unit 365 causes the imaging unit 11 to start imaging in a range in which the imaging unit 11 can capture an image (Step S110). Accordingly, the imaging unit 11 starts to sequentially output frames of a moving image obtained by imaging the first imaging area RA1 as the first captured image to the information processing device 30. As a result, the image acquiring unit 361 starts to acquire the first captured image from the imaging unit 11 in Step S110.

Then, the image analyzing unit 362 waits until one or more persons are detected from the first captured image (Step S120). That is, the image analyzing unit 362 determines whether one or more persons are included in the first captured image acquired from the imaging unit 11 in Step S120. Accordingly, in Step S120, the image analyzing unit 362 performs image analysis on the first captured image whenever the image acquiring unit 361 acquires the first captured image.

When it is determined that the one or more persons have been detected in the first captured image (Step S120: YES), the image analyzing unit 362 identifies attributes of the one or more persons on the basis of the first captured image in which the one or more persons have been detected (Step S130). The image analyzing unit 362 stores information indicating the attributes identified in Step S130 as attribute history information in the storage unit 32 until a predetermined time elapses. The predetermined time is, for example, 1 hour, but may be a time shorter than 1 hour or a time longer than 1 hour. Accordingly, for example, the information processing device 30 can identify whether a customer included in the third captured image is a person having viewed an advertisement displayed on the display device 21 in the first imaging area RA1 later. When a predetermined time elapses after certain attribute history information is stored in the storage unit 32, the image analyzing unit 362 deletes the attribute history information from the storage unit 32.

Then, the display control unit 363 reads the customer data stored in advance in the storage unit 32 and reads the customer data from the storage unit 32 (Step S140).

Then, the display control unit 363 determines one or more target advertisements on the basis of the attributes identified in Step S130 and the customer data read in Step S140 (Step S150). In the process of Step S150 is the same as described above and thus detailed description thereof will be omitted. Here, the display control unit 363 stores viewed advertisement information indicating the determined target advertisement in the storage unit 32 in correlation with the attribute history information stored in the storage unit 32 in Step S130. Accordingly, for example, the information processing device 30 can identify an advertisement which has been viewed by a customer included in the third captured image in the first imaging area RA1 later. In the following description, for the purpose of convenience of explanation, the attribute history information correlated with the viewed advertisement information in the information stored in the storage unit 32 is simply referred to as history information.

Then, the display control unit 363 reads one or more target advertisements identified in Step S150 from the storage unit 32 and causes the display device 21 to display the read one or more target advertisements (Step S160).

Then, the display control unit 363 determines whether display of an advertisement on the display device 21 is to end (Step S170). For example, when an operation of causing the information processing device 30 to end displaying of an advertisement on the display device 21 is received by the information processing device 30, the display control unit 363 determines that displaying of an advertisement on the display device 21 is to be ended. For example, when the operation is not received by the information processing device 30, the display control unit 363 determines that displaying of an advertisement on the display device 21 is not to be ended. The display control unit 363 may determine whether displaying of an advertisement on the display device 21 is to be ended using another method in Step S170.

When the display control unit 363 determines that displaying of an advertisement on the display device 21 is not to be ended (Step S170: NO), the image analyzing unit 362 waits in Step S120 until one or more persons are detected from the first captured image.

On the other hand, when it is determined that displaying of an advertisement on the display device 21 is to be ended (Step S170: YES), the display control unit 363 ends the process flow of the flowchart illustrated in FIG. 4.

As described above, the information processing device 30 causes the display device 21 to display an advertisement on the basis of customer data including information in which viewed advertisement information indicating an advertisement viewed by a customer out of advertisements displayed on the display device 21 installed at a position in the store SP, purchased product information indicating a product purchased by the customer, and customer attribute information indicating attributes of the customer are correlated and the first captured image obtained by imaging the first imaging area RA1 including a position at which an advertisement displayed on the display device 21 is visible. Accordingly, the information processing device 30 can curb displaying of an advertisement with a low effect of sales promotion on the display device.

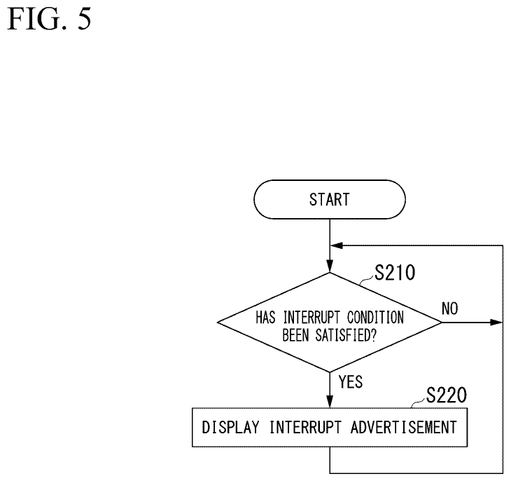

Here, the information processing device 30 can cause the display device 21 to display an advertisement different from the target advertisement through an interrupt process of the flowchart illustrated in FIG. 5 in addition to displaying of the target advertisement on the display device 21 through the process flow of the flowchart illustrated in FIG. 4. FIG. 5 is a diagram illustrating an example of a flow of an interrupt process that is performed by the information processing device 30. The information processing device 30 repeatedly performs the process flow of the flowchart illustrated in FIG. 5 in a period in which the process flow of the flowchart illustrated in FIG. 4 is being performed.

The display control unit 363 waits until a predetermined interrupt condition is satisfied (Step S210).

Here, the interrupt condition will be described. The interrupt condition includes one or more conditions. When the interrupt condition includes one condition, the information processing device 30 determines that the interrupt condition has been satisfied when one condition included in the interrupt condition has been satisfied. On the other hand, when the interrupt condition includes a plurality of conditions, the information processing device 30 determines that the interrupt condition has been satisfied when at least one of the plurality of conditions included in the interrupt condition has been satisfied.

An example in which three conditions of Conditions 1 to 3 are included in the interrupt condition will be described below.

Condition 1: Baking time information indicating a scheduled baking time is received by the information processing device 30.

Condition 2: Persons equal to or more than a predetermined threshold value are detected from the first captured image.

Condition 3: An operation of displaying the fourth captured image captured by the imaging unit 14 on the display device 21 is received by the information processing device 30.

The interrupt condition may include another condition instead of some or all of Conditions 1 to 3. The interrupt condition may include another condition in addition to some or all of Conditions 1 to 3.

Here, the information processing device 30 can receive baking time information indicating a scheduled baking time of a type of bread along with baked bread information indicating the type of bread which will be baked from now on according to an operation from a storekeeper or a kitchen staff of the store SP. When this information is received, the display control unit 363 determines that Condition 1 has been satisfied and thus that the interrupt condition has been satisfied.

When it is determined in Step S120 of FIG. 4 that persons equal to or more than the predetermined threshold value are detected from the first captured image, the display control unit 363 determines that Condition 2 has been satisfied and thus that the interrupt condition has been satisfied.

The display control unit 363 can receive an operation of displaying the fourth captured image captured by the imaging unit 14 on the display device 21. When this operation is received, the information processing device 30 determines that Condition 3 has been satisfied and thus that the interrupt condition has been satisfied.

When it is determined that the interrupt condition has been satisfied (Step S210: YES), the display control unit 363 displays an interrupt advertisement (Step S220). The process of Step S220 will be described below.

In Step S220, the display control unit 363 identifies one or more conditions satisfied in Step S210 out of the conditions included in the interrupt condition. Thereafter, the display control unit 363 generates an advertisement based on the identified one or more conditions as the interrupt advertisement and causes the display device 21 to display the generated interrupt advertisement.

For example, when it is determined in Step S210 that Condition 1 has been satisfied, the display control unit 363 generates an advertisement for notifying that the type of bread indicated by the baked bread information is baked in the time indicated by the scheduled baking time information beforehand as the interrupt advertisement on the basis of the baked bread information and the scheduled baking time information received by the information processing device 30. Then, the display control unit 363 causes the display device 21 to display the generated interrupt advertisement. Here, a method used for the display control unit 363 to generate the advertisement may be a known method or may be a method which will be developed in the future. For example, the display control unit 363 superimposes the generated interrupt advertisement on the target advertisement displayed on the display device 21. Accordingly, the information processing device 30 can cause the display device 21 to display the interrupt advertisement along with the target advertisement in Step S220.

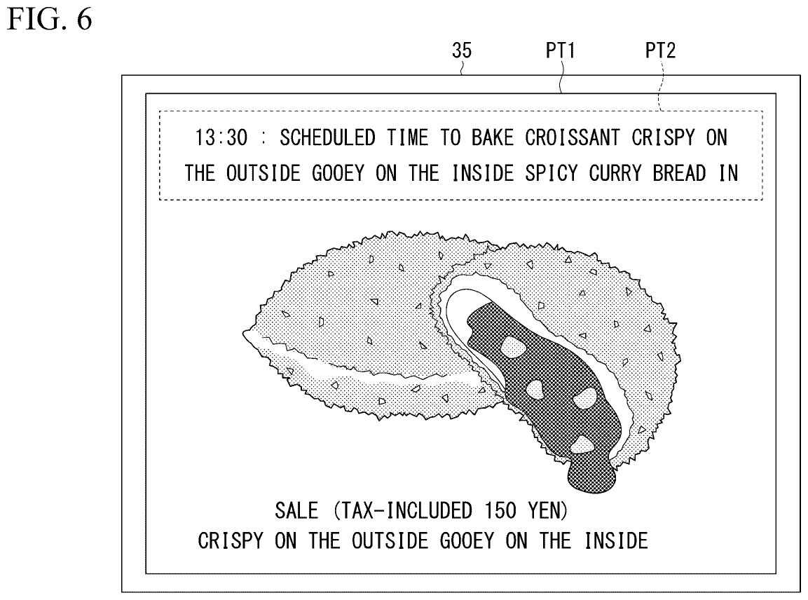

FIG. 6 is a diagram illustrating an example in which an advertisement for notifying that the type of bread indicated by the baked bread information is baked in the time indicated by the scheduled baking time information beforehand is displayed on the display device 21. In the example illustrated in FIG. 6, an interrupt advertisement PT2 superimposed on a target advertisement PT1 along with the target advertisement PT1 is displayed on the display device 21. The target advertisement PT1 is an advertisement of curry bread. On the other hand, the interrupt advertisement PT2 is an advertisement for notifying that croissant is baked at 13:30 beforehand.

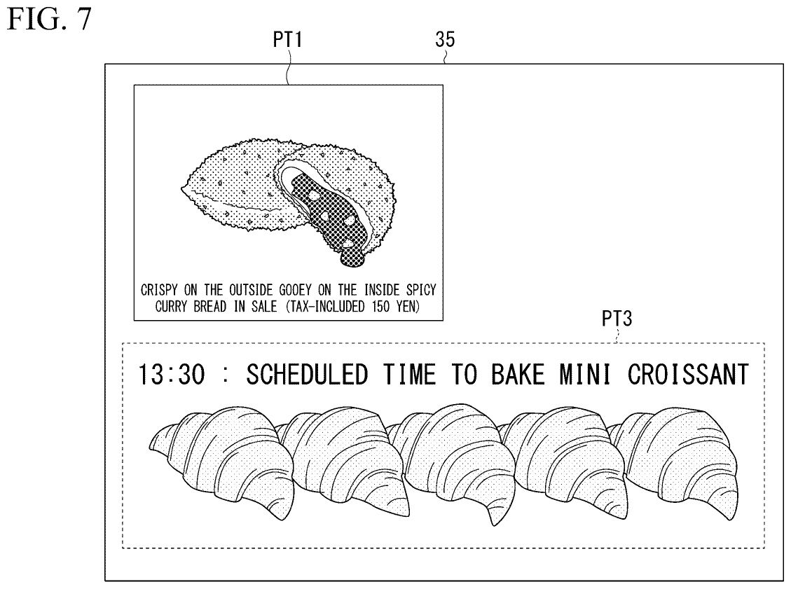

For example, as illustrated in FIG. 7, the display control unit 363 may cause the display device 21 to display the interrupt advertisement along with the target advertisement by screen division. FIG. 7 is a diagram illustrating another example in which an advertisement for notifying that the type of bread indicated by the baked bread information is baked in the time indicated by the scheduled baking time information beforehand is displayed on the display device 21. In the example illustrated in FIG. 7, an interrupt advertisement PT3 along with the target advertisement PT1 is arranged in the vertical direction on the display device 21. In this case, the information processing device 30 can cause the display device 21 to display the interrupt advertisement along with the target advertisement in Step S220.

The display control unit 363 may cause the display device 21 to display the interrupt advertisement PT2 or the interrupt advertisement PT3 by full screen display in some or all of a period until the scheduled baking time comes in.

When it is determined in Step S210 that Condition 1 has been satisfied, the display control unit 363 may cause the display device 21 to display the interrupt advertisement PT2 or the interrupt advertisement PT3 on the basis of the newest first captured image out of the acquired first captured images. For example, when it is determined in Step S210 FIG. 5 that Condition 1 has been satisfied and when it is determined in Step S150 of FIG. 4 that one or more types of bread with a highest identification frequency matches the type indicated by the baked bread information, the display control unit 363 may cause the display device 21 to display the interrupt advertisement PT2 or the interrupt advertisement PT3. Accordingly, the information processing device 30 can more reliably curb displaying of an advertisement with a low effect of sales promotion on the display device 21 in displaying an interrupt advertisement.

When the interrupt advertisement PT2 or the interrupt advertisement PT3 is displayed on the display device 21, the display control unit 363 may cause at least one of the display device 22 and the display device 23 to display the interrupt advertisement PT2 or the interrupt advertisement PT3. When the interrupt advertisement PT2 or the interrupt advertisement PT3 is displayed on all of the display devices 21 to 23, the information processing device 30 may output the number of types of sold bread indicated by the baked bread information in a predetermined period after displaying of the interrupt advertisement PT2 or the interrupt advertisement PT3 is started as information indicating an effect of sales promotion of the interrupt advertisement PT2 or the interrupt advertisement PT3. For example, an output destination of the information may be the storage unit 32, the display unit 35, another server, or another information processing device. Here, outputting of the information to the storage unit 32 means that the information is stored in the storage unit 32. Outputting of the information to the display unit 35 means that the information is displayed on the display unit 35. Accordingly, a person who wants to analyze whether there is an effect of sales promotion of the advertisement can determine whether there is an effect of sales promotion of the advertisement on the basis of the information.

For example, when it is determined in Step S210 that Condition 2 has been satisfied, the display control unit 363 reads an advertisement for notifying of a limited-time sale beforehand out of advertisements stored in advance in the storage unit 32 as the interrupt advertisement. Then, the display control unit 363 causes the display device 21 to display the read interrupt advertisement.

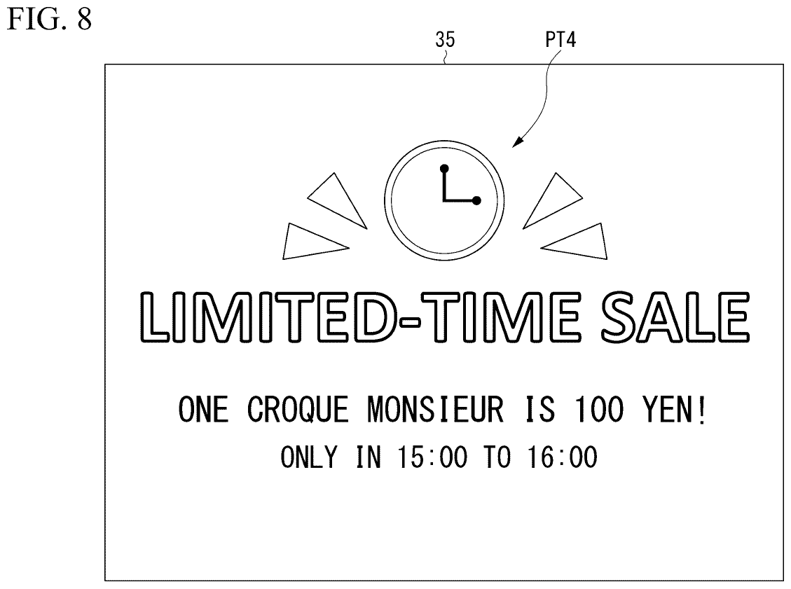

FIG. 8 is a diagram illustrating an example in which an advertisement for notifying of a limited-time sale beforehand is displayed on the display device 21. In the example illustrated in FIG. 8, an interrupt advertisement PT4 is displayed on the display device 21 by full screen display. The interrupt advertisement PT4 is an example of an advertisement for notifying of a limited-time sale which is performed in 15:00 to 16:00 in the store SP beforehand. The display control unit 363 may superimpose the interrupt advertisement PT4 on a target advertisement displayed on the display device 21. In this case, the information processing device 30 can cause the display device 21 to display the interrupt advertisement PT4 along with the target advertisement in Step S220. The display control unit 363 may cause the display device 21 to display the interrupt advertisement PT4 along with the target advertisement by screen division. In this case, the information processing device 30 can also cause the display device 21 to display the interrupt advertisement PT4 along with the target advertisement in Step S220. When the interrupt advertisement PT4 is displayed on the display device 21, the display control unit 363 may cause at least one of the display device 22 and the display device 23 to display the interrupt advertisement PT4.

An advertisement that is displayed on the display device 21 as the interrupt advertisement PT4 when Condition 2 has been satisfied may be correlated with sales-promotion product information indicating a product of which sales is to be promoted. In this embodiment, the sales-promotion product information is information indicating a type of bread (croque monsieur in the example illustrated in FIG. 8) of which sales are to be promoted. In this case, for example, when it is determined in Step S210 that Condition 2 has been satisfied and when one of one or more types of bread with a highest identification frequency in Step S150 of FIG. 4 matches the type indicated by the sales-promotion product information, the display control unit 363 causes the display device 21 to display the interrupt advertisement PT4. Accordingly, the information processing device 30 can more reliably curb displaying of an advertisement with a low effect of sales promotion on the display device in displaying an interrupt advertisement. When there are a plurality of advertisements which are candidates to be displayed as an interrupt advertisement on the display device 21 because Condition 2 has been satisfied and there are a plurality of types of bread with a highest identification frequency in Step S150 of FIG. 4, the display control unit 363 causes the display device 21 to display the interrupt advertisement as follows. That is, in this case, the display control unit 363 causes the display device 21 to display each of one or more advertisements correlated with the sales-promotion product information indicating the type matching one of the plurality of types of bread with a highest identification frequency in Step S150 of FIG. 4 as an interrupt advertisement. At this time, when there are a plurality of advertisements correlated with the sales-promotion product information indicating the type matching one of the plurality of types of bread with a highest identification frequency in Step S150 of FIG. 4, the display control unit 363 causes the display device 21 to display all of the plurality of advertisements by screen division. Accordingly, the information processing device 30 can allow a plurality of persons stopping in the first imaging area RA1 to view the interrupt advertisement with a high effect of sales promotion.

When there are a plurality of advertisements which are candidates to be displayed as an interrupt advertisement on the display device 21 because Condition 2 has been satisfied and when it is determined in Step S210 that Condition 2 has been satisfied, the display control unit 363 may cause the display device 21 to display the interrupt advertisement according to an operation from the storekeeper or the kitchen staff of the store SP. For example, in this case, the display control unit 363 causes the display unit 35 to display a list in which information indicating a plurality of types of bread is listed in the descending order of the identification frequencies in Step S150 of FIG. 4. Thereafter, using as a trigger that an operation of selecting a desired type of bread which is performed by the storekeeper or the kitchen staff of the store SP out of the types of bread listed in the list is received by the information processing device 30, the display control unit 363 causes the display device 21 to display an advertisement correlated with the sales-promotion product information indicating the received type of bread as the interrupt advertisement. Accordingly, when the number of persons stopping in the first imaging area RA1 is large, the information processing device 30 can cause the display device 21 to display the interrupt advertisement desired by the storekeeper or the kitchen staff of the store SP. As a result, the information processing device 30 can enhance the effect of sales promotion using the interrupt advertisement. The display control unit 363 may receive information indicating an advertisement to be displayed on the display device 21 when Condition 2 has been satisfied at a timing before it is determined in Step S210 that Condition 2 has been satisfied. In this case, for example, when the type indicated by the sales-promotion product information correlated with the advertisement indicated by the information received at the timing matches the type of bread with a highest identification frequency in Step S150 of FIG. 4, the display control unit 363 causes the display device 21 to display the advertisement as the interrupt advertisement.

In Step S210, the display control unit 363 may determine that Condition 2 has been satisfied when persons equal to or more than a predetermined threshold value have been detected in one first captured image, determine that Condition 2 has been satisfied when the sum of persons detected in a plurality of first captured images acquired in a predetermined time period is equal to or more than a predetermined threshold value, or determine that Condition 2 has been satisfied using another method.

For example, when it is determined in Step S210 that Condition 3 has been satisfied, the display control unit 363 cause the display device 21 to display a moving image (that is, a moving image with the fourth captured image as a frame) acquired from the imaging unit 14 as an interrupt advertisement. Accordingly, the storekeeper or the kitchen staff of the store SP can allow a customer to view, for example, a moving image including freshly baked bread as an interrupt advertisement at a desired timing.

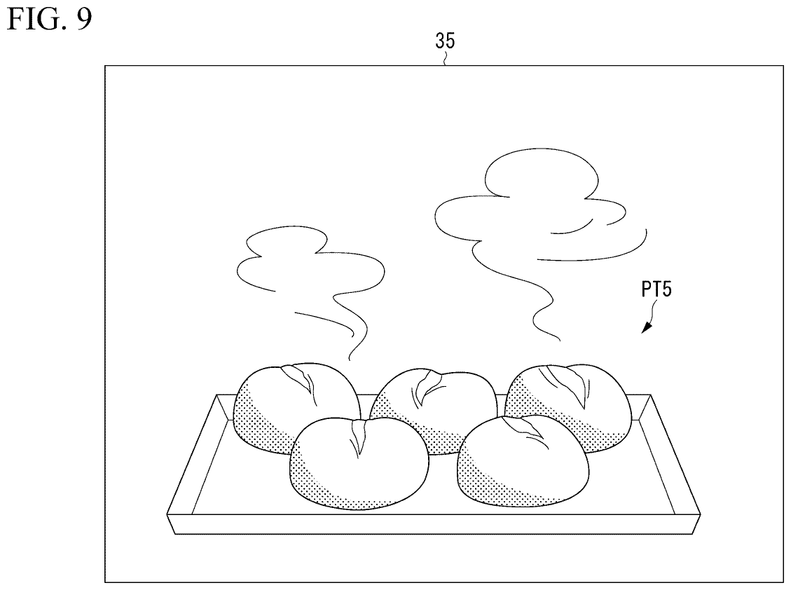

FIG. 9 is a diagram illustrating an example in which a moving image including freshly baked bread is displayed as an interrupt advertisement on the display device 21. In the example illustrated in FIG. 9, an interrupt advertisement PT5 is displayed on the display device 21 by full screen display. The interrupt advertisement PT5 is an example of an advertisement including freshly baked bread in the store SP. The display control unit 363 may superimpose the interrupt advertisement PT5 on target advertisement displayed on the display device 21. In this case, the information processing device 30 can cause the display device 21 to display the interrupt advertisement PT5 along with the target advertisement in Step S220. The display control unit 363 may cause the display device 21 to display the interrupt advertisement PT5 along with the target advertisement by screen division. In this case, the information processing device 30 can cause the display device 21 to display the interrupt advertisement PT5 along with the target advertisement in Step S220. When the interrupt advertisement PT5 is displayed on the display device 21, the display control unit 363 may cause at least one of the display device 22 and the display device 23 to display the interrupt advertisement PT5.

When two or more of Conditions 1 to 3 have been satisfied, the display control unit 363 may cause the display device 21 to display interrupt advertisements corresponding to the satisfied two or more conditions by screen division or the like.

After the process of Step S220 has been performed, the display control unit 363 causes the process flow to proceed to Step S210 and waits again until an interrupt condition is satisfied.

As described above, the information processing device 30 causes the display device 21 to display the interrupt advertisement when the interrupt condition has been satisfied. Accordingly, the information processing device 30 can allow a customer to view an advertisement including details desired by the storekeeper or the kitchen staff of the store SP as an interrupt advertisement at a desired timing. As a result, the information processing device 30 can enhance the effect of sales promotion.

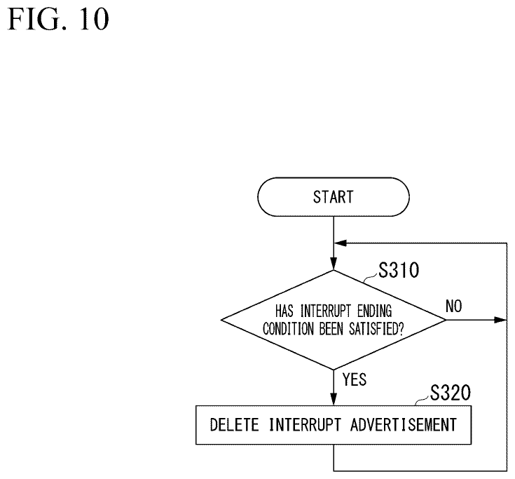

Displaying of an interrupt advertisement performed in this way is ended through the process flow of the flowchart illustrated in FIG. 10. FIG. 10 is a diagram illustrating an example of a process flow of ending displaying of an interrupt advertisement which is performed by the information processing device 30. For example, the information processing device 30 repeatedly performs the process flow of the flowchart illustrated in FIG. 10 in a period in which an interrupt advertisement is displayed on the display device 21.

The display control unit 363 waits until a predetermined interrupt ending condition is satisfied (Step S310).

The interrupt ending condition will be described below. The interrupt ending condition includes conditions correlated with the conditions included in the interrupt condition. In this embodiment, the interrupt condition includes Conditions 1 to 3. In this case, the interrupt ending condition includes Ending Condition 1 correlated with Condition 1, Ending Condition 2 correlated with Condition 2, and Ending Condition 3 correlated with Condition 3. The information processing device 30 determines that the interrupt ending condition has been satisfied when at least one of one or more ending conditions included in the interrupt ending condition has been satisfied. That is, in this embodiment, the information processing device 30 determines that the interrupt ending condition has been satisfied when at least one of Ending Conditions 1 to 3 included in the interrupt ending condition has been satisfied.

In the following description, for example, it is assumed that the conditions included in the interrupt ending condition are three conditions of Ending Conditions 1 to 3.

Ending Condition 1: A scheduled baking time elapses.

Ending Condition 2: Persons less than a predetermined threshold value are detected in the first captured image.

Ending Condition 3: An operation of ending displaying of the fourth captured image captured by the imaging unit 14 on the display device 21 is received by the information processing device 30.

The interrupt condition may include another condition in addition to the conditions correlated with the conditions included in the interrupt condition such as Ending Conditions 1 to 3 or instead of some of all of the conditions correlated with the conditions included in the interrupt condition such as Ending Conditions 1 to 3. The other condition is a condition that an operation of ending displaying of an interrupt advertisement is received by the information processing device 30, or the like but the present invention is not limited thereto.

When it is determined that the interrupt ending condition has been satisfied (Step S310: YES), the display control unit 363 ends displaying of an interrupt advertisement on the display device 21 (Step S320). The process of Step S320 will be described below.

For example, when it is determined in Step S210 that Ending Condition 1 has been satisfied, the display control unit 363 ends displaying of the interrupt advertisement (for example, the interrupt advertisement PT2 or the interrupt advertisement PT3) displayed on the display device 21 because Condition 1 has been satisfied on the display device 21.

For example, when it is determined in Step S210 that Ending Condition 2 has been satisfied, the display control unit 363 ends displaying of the interrupt advertisement (for example, the interrupt advertisement PT4) displayed on the display device 21 because Condition 2 has been satisfied on the display device 21.

For example, when it is determined in Step S210 that Ending Condition 3 has been satisfied, the display control unit 363 ends displaying of the interrupt advertisement (for example, the interrupt advertisement PT5) displayed on the display device 21 because Condition 3 has been satisfied on the display device 21.

After the process of Step S320 has been performed, the display control unit 363 causes the process flow to proceed to Step S310 and waits again until the interrupt ending condition is satisfied. After the process of Step S320 has been performed, the display control unit 363 ends the process flow of the flowchart illustrated in FIG. 10 when an interrupt advertisement is not displayed on the display device 21.

The information processing device 30 may not perform the process flows of the flowchart illustrated in FIGS. 5 and 10. That is, the information processing device 30 may not cause the display device 21 to display an interrupt advertisement.

### <Process Flow of Generating Customer Data Performed by Information Processing Device>

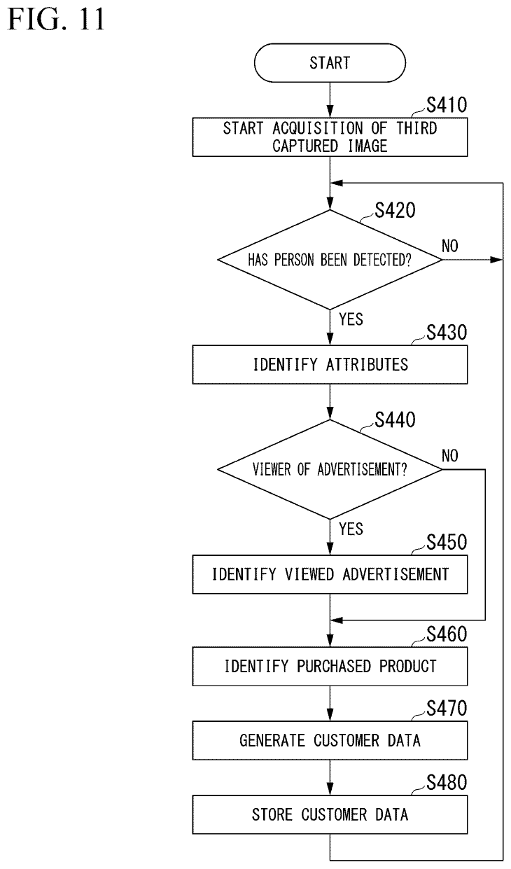

The aforementioned information processing device 30 may generate customer data. In this case, the information processing device 30 generates customer data through the process flow of the flowchart illustrated in FIG. 11. FIG. 11 is a diagram illustrating an example of a process flow of generating customer data that is performed by the information processing device 30. For example, the information processing device 30 repeatedly performs the process flow of the flowchart illustrated in FIG. 11 in a period in which the process flow of the flowchart illustrated in FIG. 4 is being performed.

The imaging control unit 365 causes the imaging unit 13 to start imaging in a range which can be imaged by the imaging unit 13 (Step S410). Accordingly, the imaging unit 13 starts sequential outputting of frames of a moving image obtained by imaging the third imaging area RA3 as the third captured image to the information processing device 30. As a result, the image acquiring unit 361 starts acquisition of the third captured image from the imaging unit 13 in Step S410.

Then, the image analyzing unit 362 waits until one or more persons are detected in the third captured image (Step S420). That is, in Step S420, the image analyzing unit 362 determines whether one or more persons are included in the third captured image acquired from the imaging unit 13. Accordingly, in Step S420, the image analyzing unit 362 performs image analysis on the third captured image whenever the image acquiring unit 361 acquires the third captured image.

When it is determined that one or more persons have been detected in the third captured image (Step S420: YES), the image analyzing unit 362 identifies attributes a person closest to the register counter RG out of the one or more persons as target attributes on the basis of the third captured image in which the one or more persons have been detected (Step S430).

Then, the data generating unit 364 determines whether a person with the target attributes identified by the image analyzing unit 362 in Step S430 is a viewer having viewed an advertisement displayed on the display device 21 in the first imaging area RA1 (Step S440). For example, when history information including attribute history information indicating the target attributes is stored in the storage unit 32, the data generating unit 364 determines that the person with the target attributes is the viewer. On the other hand, for example, when the history information is not stored in the storage unit 32, the data generating unit 364 determines that the person with the target attributes is not the viewer.

When it is determined that the person with the target attributes identified in Step S430 is the viewer having viewed the advertisement displayed on the display device 21 in the first imaging area RA1 (Step S440: YES), the data generating unit 364 reads target history information from the storage unit 32. The target history information is history information including the attribute history information indicating the target attributes. Then, the data generating unit 364 identifies an advertisement indicated by the viewed advertisement information included in the read target history information as the advertisement viewed by the person.

Then, the image analyzing unit 362 identifies a type of bread to be purchased by the person or a type of bread purchased by the person as a purchased product on the basis of the third captured image including the person with the target attributes identified in Step S430 (Step S460). A method of identifying the purchased product may be a known method or may be a method which will be developed in the future. The image analyzing unit 362 may identify the purchased product on the basis of information acquired from a cash register, a POS system, or the like installed at the register counter RG in Step S460. The process of Step S450 and the process of Step S460 may be performed in parallel.

The data generating unit 364 generates new customer identification information and generates customer data as information including the generated customer identification information, the viewed advertisement information indicating the advertisement identified in Step S450, the purchased product information indicating the purchased product identified in Step S460, and the customer attribute information indicating the target attributes identified in Step S430 (Step S470). Then, the data generating unit 364 stores the customer data generated in Step S470 in the storage unit 32 (Step S480). After the process of Step S480 has been performed, the image analyzing unit 362 causes the process flow to proceed to Step S420 and waits again until one or more persons are detected in the third captured image.

On the other hand, when it is determined that the person with the target attributes identified in Step S430 is not the viewer having viewed the advertisement displayed on the display device 21 in the first imaging area RA1 (Step S440: NO), the data generating unit 364 causes the process flow to proceed to Step S460 and identifies a type of bread to be purchased by the person or a type of bread purchased by the person as a purchased product on the basis of the third captured image including the person with the target attributes. In this case, in Step S460, the data generating unit 364 generates viewed advertisement information indicating that the person with the target attributes has not viewed the advertisement and generates customer data as information including the generated viewed advertisement information, the generated customer identification information, the purchased product information indicating the purchased product identified in Step S460, and the customer attribute information indicating the target attributes.

As described above, the information processing device 30 identifies an advertisement viewed by a certain customer out of advertisements displayed on the display device 21, a product purchased by the customer, and attributes the customer on the basis of the second captured image obtained by imaging the second imaging area RA2 in the area in the store SP and the first captured image obtained by imaging the first imaging area RA1 and generates customer data on the basis of the identified advertisement, the identified product, and the identified attributes. Accordingly, the information processing device 30 can curb displaying of an advertisement with a low effect of sales promotion on the display device 21 on the basis of the generated customer data.

The information processing device 30 may not perform the process flow of the flowchart illustrated in FIG. 11. In this case, the information processing device 30 performs the process flow of the flowchart illustrated in FIG. 4 on the basis of customer data generated by another device.

### Modified Example 1 of Embodiment

Modified Example 1 of the embodiment will be described below. In Modified Example 1 of the embodiment, the information processing device 30 is a server that is installed outside of the store SP. In this case, an information processing terminal that acquires images captured by the imaging units 11 to 14 and outputs the acquired images to the information processing device 30 is installed in the store SP. The information processing device 30 acquires a first captured image, a second captured image, a third captured image, and a fourth captured image from the information processing terminal, performs the process flows of the flowcharts illustrated in FIGS. 4, 5, 10, and 11, and displays advertisements on the display devices 21 to 24 via the information processing terminal on the basis of the acquired images. In this case, the information processing device 30 stores customer data of other stores in addition to the customer data of the store SP. As a result, the information processing device 30 can cause the display device 21 to display an advertisement with a high effect of sales promotion with higher accuracy. In other words, in this case, the information processing device 30 more reliably curb displaying of an advertisement with a low effect of sales promotion on the display device 21.

### Modified Example 2 of Embodiment

Modified Example 2 of the embodiment will be described below. In Modified Example 2 of the embodiment, customer data may be stored in a server that is installed outside of the store SP. In this case, the information processing device 30 uses the server instead of the storage unit 32. Accordingly, the communication unit 34 of the information processing device 30 communicates with the server in which customer data is stored.

### Modified Example 3 of Embodiment

Modified Example 3 of the embodiment will be described below. In Modified Example 3 of the embodiment, regional information indicating a region to which the store SP belongs is included in the customer data. In this case, the customer data is data including information in which viewed advertisement information, purchased product information, customer attribute information, and the regional information are correlated. Accordingly, for example, the information processing device 30 can generate customer data appropriate for rationality of the customer through the process flow of the flowchart illustrated in FIG. 11. When Modified Example 1 of the embodiment and Modified Example 2 of the embodiment are combined, the information processing device 30 can cause the display device 21 to display an advertisement appropriate for rationality of a customer, for example, through the process flow of the flowchart illustrated in FIG. 4.

### Modified Example 4 of Embodiment

Modified Example 4 of the embodiment will be described below. In Modified Example 4 of the embodiment, situation information indicating a situation in the first imaging area RA1 is included in the customer data. In this case, the customer data is data including information in which viewed advertisement information, purchased product information, customer attribute information, and the situation information are correlated. Here, the situation in the first imaging area RA1 is represented by weather, temperature, humidity, and the like of a region including the store SP. Accordingly, the situation information is information indicating weather, temperature, humidity, and the like of the region including the store SP. The information processing device 30 can acquire the situation information, for example, via the Internet. Accordingly, the information processing device 30 acquires the situation information from the Internet, for example, in Step S470 of FIG. 11 and generates customer data including the acquired situation information. For example, in Step S150 of FIG. 4, the information processing device 30 acquires the situation information from the Internet and determines one or more target advertisements on the basis of the acquired situation information, the attributes identified in Step S130, and the customer data read in Step S140. Accordingly, the information processing device 30 can cause the display device 21 to display an advertisement based on the attributes identified in Step S130 and the weather, temperature, humidity, and the like of the region including the store SP. That is, the information processing device 30 can cause the display device 21 to display an advertisement based on taste which can vary depending on the situation of the first imaging area RA1. As a result, the information processing device 30 can more reliably curb displaying of an advertisement with a low effect of sales promotion on the display device.

### Modified Example 5 of Embodiment

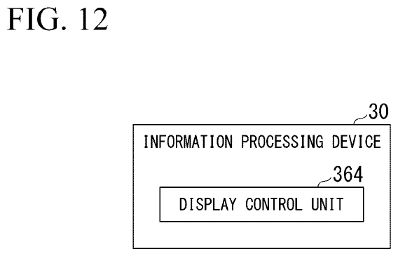

The information processing device 30 may have a configuration illustrated in FIG. 12. FIG. 12 is a diagram illustrating another example of the functional configuration of the information processing device 30. That is, the information processing device 30 includes the display control unit 363 configured to cause the display device 21 to display an advertisement on the basis of customer data including information in which viewed advertisement information indicating an advertisement viewed by a first customer out of advertisements displayed on the display device 21 installed in at a position in a store SP, purchased product information indicating a product purchased by the first customer, and customer attribute information indicating attributes of the first customer are correlated and a first captured image obtained by imaging a first imaging area RA1 including a position at which an advertisement displayed on the display device 21 is visible. Accordingly, the information processing device 30 can curb displaying of an advertisement with a low effect of sales promotion on the display device.

### Modified Example 6 of Embodiment

The first target record may be a record in which a predetermined first specific condition is satisfied out of records included in customer data when no person is included in the first captured image and a record satisfying a predetermined second specific condition out of records included in customer data when a person is included in the first captured image. In the following description, it is assumed that the first target record satisfying the first specific condition is an eleventh target record for the purpose of convenience of explanation. In the following description, it is also assumed that the first target record satisfying the second specific condition is a twelfth target record for the purpose of convenience of explanation.

The first specific condition is a record in which a product correlated with an advertisement indicated by viewed advertisement information and a product indicated by purchased product information match. Here, a product correlated with an advertisement indicated by certain viewed advertisement information is a product of which sales is to be promoted by the advertisement. For example, when an advertisement indicated by certain viewed advertisement information is an advertisement for promoting sales of croissant, a product correlated with the advertisement is croissant. In the following description, an advertisement correlated with a certain product is referred to as an advertisement of the product for the purpose of convenience of explanation.

The second specific condition is a record including customer attribute information matching the customer attribute information indicating attributes of a person identified in the first captured image by the information processing device 30 and a record in which a product correlated with an advertisement indicated by viewed advertisement information and a product indicated by purchased product information match.

In Modified Example 6 of the embodiment, the information processing device 30 determines whether one or more persons are included in the first captured image acquired from the imaging unit 11 whenever the first captured image is acquired from the imaging unit 11.

When no persons are included in the first captured image acquired from the imaging unit 11, the information processing device 30 identifies one or more records satisfying the first specific condition as the eleventh target record out of customer data instead of determining a predetermined first image as a target advertisement to be displayed on the display device 21. In this case, the eleventh target record is a record for a person having purchased a product correlated with the viewed advertisement out of records included in the customer data. That is, an advertisement indicated by the viewed advertisement information included in the eleventh target record is an advertisement of which a product correlated with the advertisement is more likely to be sold. When one eleventh target record has been identified, the information processing device 30 identifies an advertisement indicated by the viewed advertisement information included in the identified eleventh target record as a target record. Then, the information processing device 30 causes the display device 21 to display the identified target advertisement. For example, when a plurality of eleventh target records have been identified, the information processing device 30 identifies a type of bread indicated by the purchased product information included in each of the identified plurality of eleventh target records. The information processing device 30 identifies a type of bread with a highest identification frequency out of the identified types of bread as target bread. After the target bread has been identified, the information processing device 30 identifies the eleventh target record including the purchased product information indicating the identified target bread out of the identified plurality of eleventh target records as a second target record. When the number of identified second target records is one, the information processing device 30 identifies an advertisement indicated by the viewed advertisement information included in the identified second target record as a target advertisement. When the number of identified second target records is two or more, the information processing device 30 identifies advertisements indicated by the viewed advertisement information included in the identified plurality of second target records. The information processing device 30 identifies an advertisement with a highest identification frequency out of the identified advertisements as a target advertisement. The information processing device 30 causes the display device 21 to display the identified target advertisement. Accordingly, when no person is included in the first captured image acquired from the imaging unit 11, the information processing device 30 can cause the display device 21 to display an advertisement of which a product can be more likely to be sold.

On the other hand, for example, when one person is included in the first captured image acquired from the imaging unit 11, the information processing device 30 identifies attributes of the person on the basis of the first captured image. After the attributes of the person have been identified, the information processing device 30 identifies one or more records satisfying the second specific condition out of the customer data as the twelfth target record. In this case, the twelfth target record is a record corresponding to attributes of the person and a record for the person having purchased a product correlated with the viewed advertisement out of records included in the customer data. That is, an advertisement indicated by the viewed advertisement information included in the eleventh target record is an advertisement which a product correlated with is more likely to be sold by the person. For example, when one first target record has been identified, the information processing device 30 identifies an advertisement indicated by the viewed advertisement information included in the identified first target record as a target advertisement. Then, the information processing device 30 causes the display device 21 to display the identified target advertisement. For example, when a plurality of first target records have been identified, the information processing device 30 identifies a type of bread indicated by the purchased product information included in each of the identified plurality of first target records. The information processing device 30 identifies a type of bread with a highest identification frequency out of the identified types of bread as target bread. After the target bread has been identified, the information processing device 30 identifies the first target record including the purchased product information indicating the identified target bread out of the identified plurality of first target records as a second target record. When the number of identified second target records is one, the information processing device 30 identifies an advertisement indicated by the viewed advertisement information included in the identified second target record as a target advertisement. When the number of identified second target records is two or more, the information processing device 30 identifies advertisements indicated by the viewed advertisement information included in the identified plurality of second target records. The information processing device 30 identifies an advertisement with a highest identification frequency out of the identified advertisements as a target advertisement. The information processing device 30 causes the display device 21 to display the identified target advertisement. Accordingly, when one person is included in the first captured image acquired from the imaging unit 11, the information processing device 30 can cause the display device 21 to display an advertisement of which a product can be more likely to be sold by the person. As a result, the information processing device 30 can more reliably curb displaying of an advertisement with a low effect of sales promotion on the display device 21 for the person included in the first captured image.

For example, when a plurality of persons are included in the first captured image acquired from the imaging unit 11, the information processing device 30 identifies a target advertisement using the aforementioned methods for each of the plurality of persons. At this time, the information processing device 30 identifies the same target advertisements as one target advertisement. The information processing device 30 causes the display device 21 to display all of the one or more target advertisements identified in this way by screen division. Accordingly, when a plurality of persons are included in the first captured image acquired from the imaging unit 11, the information processing device 30 can cause the display device 21 to display an advertisement of which a product can be more likely to be sold by each of the plurality of persons. As a result, the information processing device 30 can more reliably curb displaying of an advertisement with a low effect of sales promotion on the display device 21 for the persons included in the first captured image.

The aforementioned description may be combined in any way.

While an embodiment of the present invention has been described above with reference to the drawings, a specific configuration of the present invention is not limited to the embodiment and may be subjected to modifications, substitutions, omissions, and the like without departing from the gist of the present invention.

A program for realizing a function of an arbitrary constituent unit of the aforementioned device may be executed by recording the program on a computer-readable recording medium and causing a computer system to read the program. Here, an example of the device is the information processing device 30. The “computer system” mentioned herein includes an OS or hardware such as peripherals. The “computer-readable recording medium” means a portable medium such as a flexible disk, a magneto-optical disc, a ROM, or a compact disk (CD)-ROM or a storage device such as a hard disk incorporated into the computer system. The “computer-readable recording medium” includes a medium that holds a program for a predetermined time such as a volatile memory in a computer system serving as a server or a client when the program is transmitted via a network such as the Internet or a communication line such as a telephone line.

The program may be transmitted from a computer system storing the program in a storage device or the like to another computer system via a transmission medium or using carrier waves in the transmission medium. Here, the “transmission medium” for transmitting a program is a medium having a function of transmitting information such as a network such as the Internet or a communication line such as a telephone line.

The program may be for realizing some of the aforementioned functions. The program may be a program for realizing the aforementioned functions in combination with a program recorded in advance in the computer system, that is, a differential file or a differential program.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### REFERENCE SIGNS LIST

1 Information processing system
11, 12, 13, 14 Imaging unit
21, 22, 23, 24 Display device
30 Information processing device
31 Processor
32 Storage unit
33 Input receiving unit
34 Communication unit
35 Display unit
36 Control unit
361 Image acquiring unit
362 Image analyzing unit
363 Display control unit
364 Data generating unit
365 Imaging control unit
ENT Entrance
RA1 First imaging area
RA2 Second imaging area
RA3 Third imaging area
RA4 Fourth imaging area
RG Register counter
RM1 Kitchen
RM2 Hall
SP Store

What is claimed is:

1. An information processing device comprising a display control unit configured to cause a display device installed at a position in a store to display an advertisement on the basis of:
customer data including information in which viewed advertisement information indicating an advertisement viewed by a first customer out of advertisements displayed on the display device, purchased product information indicating a product purchased by the first customer, and customer attribute information indicating attributes of the first customer are correlated; and
a first captured image in which a first imaging area including a position at which an advertisement displayed on the display device is visible is imaged.

2. The information processing device according to claim 1, wherein the customer data is data in a table format including a record in which the viewed advertisement information, the purchased product information, and the customer attribute information are correlated,
wherein the display control unit identifies one or more first target records satisfying a first specific condition out of the customer data and causes the display device to display an advertisement on the basis of the identified one or more first target records when no person is included in the first captured image, and
wherein the first specific condition is a record in which a product correlated with the advertisement indicated by the viewed advertisement information and a product indicated by the purchased product information match.

3. The information processing device according to claim 2, wherein the display control unit identifies the one or more first target records, identifies a product with a highest identification frequency on the basis of the identified one or more first target records, and causes the display device to display an advertisement of the identified product when no person is included in the first captured image.

4. The information processing device according to claim 1, wherein the display control unit identifies attributes of a second person and causes the display device to display an advertisement on the basis of the identified attributes of the second person and the customer data when a second person is included in the first captured image.

5. The information processing device according to claim 4, wherein the customer data is data in a table format including a record in which the viewed advertisement information, the purchased product information, and the customer attribute information are correlated,
wherein the display control unit identifies one or more first target records satisfying a second specific condition out of the customer data on the basis of the identified attributes of the second person and causes the display device to display an advertisement on the basis of the identified one or more first target records when the second person is included in the first captured image, and
wherein the second specific condition is a record which includes the customer attribute information indicating attributes of the second person and in which a product correlated with the advertisement indicated by the viewed advertisement information and a product indicated by the purchased product information match.

6. The information processing device according to claim 5, wherein the display control unit identifies the one or more first target records, identifies a product with a highest identification frequency on the basis of the identified one or more first target records, and causes the display device to display an advertisement of the identified product when the second person is included in the first captured image.

7. The information processing device according to claim 1, further comprising:
a storage unit configured to store the customer data.

8. The information processing device according to claim 1, further comprising:
a communication unit configured to communicate with a server storing the customer data.

9. The information processing device according to claim 1, wherein the customer data includes information in which the viewed advertisement information, the purchased product information, the customer attribute information, and situation information indicating a situation in the first imaging area are correlated, and
wherein the display control unit causes the display device to display an advertisement based on attributes of a person and the situation in the first imaging area on the basis of the first captured image and the customer data when the person is included in the first captured image.

10. The information processing device according to claim 1, further comprising:
a generation unit configured to identify an advertisement viewed by the first customer out of advertisements displayed on the display device, a product purchased by the first customer, and attributes of the first customer on the basis of a second captured image in which a second imaging area including a position at which the first customer performs a procedure for purchasing a product in the area of the store is imaged and the first captured image and to generate the customer data on the basis of the identified advertisement, the identified product, and the identified attributes.

11. The information processing device according to claim 1, wherein the display control unit causes the display device to display an advertisement according to a predetermined interrupt condition when the interrupt condition has been satisfied.

12. The information processing device according to claim 11, wherein the interrupt condition includes a plurality of conditions, and
wherein the display control unit determines that the interrupt condition has been satisfied when at least one of the plurality of conditions has been satisfied and causes the display device to display an advertisement based on the satisfied at least one condition.

13. An information processing device comprising:
a generation unit configured to generate information including:
viewed advertisement information indicating an advertisement viewed by a first customer out of advertisements displayed on a display device installed in a store,
purchased product information indicating a product purchased by the first customer, and
customer attribute information indicating attributes of the second customer as customer data
on the basis of: a second captured image in which a second imaging area including a position at which the first customer performs a procedure for purchasing a product in an area in the store is imaged; and a first captured image in which a first imaging area including a position at which an advertisement displayed on the display device is visible is imaged.

14. An information processing system comprising:
a display device installed at a position in a store; and
an information processing device configured to cause the display device to display an advertisement,
wherein the information processing device comprises: a display control unit configured to cause the display device to display an advertisement on the basis of:
customer data including information in which viewed advertisement information indicating an advertisement viewed by a first customer out of advertisements displayed on the display device, purchased product information indicating a product purchased by the first customer, and customer attribute information indicating attributes of the first customer are correlated; and
a first captured image in which a first imaging area including a position at which an advertisement displayed on the display device is visible is imaged.

15. An information processing method comprising:
causing a display device installed at a position in a store to display an advertisement on the basis of:
customer data including information in which there are correlated viewed advertisement information indicating an advertisement viewed by a first customer out of advertisements displayed on the display device, purchased product information indicating a product purchased by the first customer, and customer attribute information indicating attributes of the first customer; and
a first captured image in which a first imaging area including a position at which an advertisement displayed on the display device is visible is imaged.
